(19) United States
(12) Patent Application Publication
(10) Pub. No.: US 2004/0013848 A1
(43) Pub. Date: Jan. 22, 2004

(54) Floor covering system for conveying information in public or private locations

(76) Inventors: Seiin Kobayashi, Yonezawa (JP); Mamiko Yamada, Yonezawa (JP); Takuya Honda, Takatsuki (JP)

Correspondence Address: Charlotte C. Wilson, Legal Department, M-495, PO Box 1926, Spartanburg, SC, 29304, US

(21) Appl. No.: 10/460,805

(22) Filed: Jun. 12, 2003

Related U.S. Application Data
(60) Provisional application No. 60/388,336, filed on Jun. 13, 2002.

(51) Int. Cl. B32B 3/02

(52) U.S. Cl. 428/85; 428/195.1

(57) ABSTRACT

The present mat system includes a plurality of mats intended to convey specific and needed information, in interior locations, to the end-user's customers or family. These mats are printed with words, letters, or symbols that convey the desired information. The information may be printed in any language or dialect, even incorporating slang or colloquial expressions. By using these mats, the end-users indicate their care and appreciation for their customers or family. In one embodiment, the mats include a textile upper surface (such as a pile surface) and a solid backing. Because the mats are printed with reactive dyes, they are more capable of withstanding vigorous laundering without causing dye transfer onto other mats.

### CROSS-REFERENCE TO RELATED APPLICATIONS

This application is a nonprovisional application that claims priority to U.S. provisional application, serial No. 60/388,336, filed Jun. 13, 2003.

### TECHNICAL FIELD

The present disclosure relates to a system for conveying information in public or private areas, through using floor mats on which the information is printed. Specifically, these dust control mats include a textile upper surface and a durable backing surface. The mat system functions not only to clean the feet of pedestrians and to prevent adjacent flooring surfaces from becoming soiled, but also to provide information directed to the mat users. The mat system is, of course, useful in entryways where conventional dust control mats are used, but is preferably used in other areas of a building where its aesthetic appearance and its printed message are desired.

### BACKGROUND

Typically, dust control mats—mats having a textile upper surface and a rubber or other solid backing—are placed only in the entryways of a building or home. This placement is optimal for meeting the sole objectives of the mat, that being to clean the feet of crossing mat users and to maintain a clean adjacent flooring surface. Regardless of the nature of the adjacent flooring surface, facility managers recognize the importance of a clean and safe flooring surface for their patrons and employees. For instance, a facility manager uses dust control mats to capture dirt and moisture from pedestrian footwear, thus preventing dirt and moisture from being transported onto adjacent surfaces that might become slippery when wet. Likewise, these mats are also used in a private setting (such as a home) for capturing dirt.

Heretofore, there has been little use of dust control mats in locations away from entryways (that is, in interior locations). In many instances, facility managers have not used mats in interior locations because there is a relatively small need for dust control in those locations. Furthermore, because conventional dust control mats function only as their name would indicate, their aesthetic appearance has not justified the costs of purchasing or renting mats for use in these interior locations. In home environments, individuals have not generally been inclined to use floor mats throughout their home, because of the lack of aesthetic appeal of many mat products.

By contrast, the mat system of the present disclosure is patterned in such a way that it conveys a message to the end-user and his customers or family that is pertinent to the area where it is placed. For example, a mat with the message “Make Deposits Here” may be used to direct bank patrons to the appropriate teller window. In a home, a mat with the message “Happy Anniversary” or other festive message may be used to celebrate special occasions. Additionally, the mat system described herein is aesthetically pleasing to the end-user and his customers (or family, in the case of private use), while at the same time conveying needed information. It is believed that customers view the mat system as a good-will gesture from the business operators, thus building customer loyalty. Similarly, in a home, the present mats convey a sense of caring to family members and visitors to the home.

Traditionally, floor mats have been printed with conventional acid dyes, which are used because of their ability to resist fading in direct or indirect sunlight As has been discussed above, this characteristic is especially important due to the placement of conventional mats in entryways (where they are likely to be exposed to ultraviolet light). Although acid dyes are substantially light-fast, their washfastness has been problematic for industrial laundries.

Acid dyes tend to migrate during industrial laundry conditions, which causes the dye from one mat to be transferred to another. The result is that the surface of lightcolored mats tends to become dingy with the transferred dyes. Dark-colored mats, which lose dye during the laundering process, also experience degradation in their appearance due to fading. It can be said, then, that dye transfer negatively impacts the appearance of both light- and dark-colored mats. To combat this problem, industrial laundries must segregate mats by color, thus adding to their labor costs.

The present mat system addresses the problem of dye transfer by dyeing the mats with reactive dyes. Reactive dyes are extremely wash-fast, as compared with conventional acid dyes. The use of reactive dyes allows mats of different colors to be laundered together without fear of dye transfer during the laundering process.

Although reactive dyes are less light-fast than conventional acid dyes, the placement and/or use of the mats of the present disclosure is such that light-fastness is less of an issue. Because the mats of the present disclosure are placed in interior portions of a building (and, therefore, away from direct sunlight), these mats do not require the use of light-resistant dyestuffs. Alternately, in certain embodiments of the present mat system as will be discussed herein, the limited use of selected printed mats allows reactive-dyed mats to be placed in any location in a private or public environment.

Apart from conventional acid-dyed mats described above, mats made with solution dyed yarns (such as nylon) are also available. Although fading is less of a problem with solution dyed yarns (because the pigment is incorporated into the yarn), creating a message on the mat surface is cumbersome and time-consuming. The majority of message mats made with solution dyed yarns are created by graphic tufting machines, which have limitations in terms of number of colors, production speed, design resolution, and design intricacy.

The present mat system is printed with reactive dyes, preferably on dye injection equipment, thus giving the end-user a wide spectrum of color choices and an infinite range of design options. Production time and costs are also lower with the present mat system, as compared with the graphic tufting machine.

The present mat system provides a means for an end-user to convey a sense of caring and appreciation to their customers and/or employees. Alternately, in a private setting, the present mat system conveys a sense of caring to the mat user's family and friends. The mat system includes a durable, attractive product that endears the end-user to his customer, because, with its use, the end-user is perceived to be providing the customer with a personal added service. As has been described above, conventional mats do not provide this advantage, those mats being designed primarily for functionality rather than aesthetic appeal. The mat system described herein has the advantage of being both functional and aesthetically pleasing. Additionally, and most importantly, the mat system conveys needed and specific messages to the end-user's customers or family.

### SUMMARY

The present mat system includes a plurality of mats intended to convey specific and needed information, in interior locations, to the end-user's customers or family. The mat system, also referred to as a display system, is typically used in association with buildings. These mats are printed with words, letters, or symbols that convey the desired information. The information may be printed in any language or dialect, even incorporating slang or colloquial expressions. By using these mats, the end-users indicate their care and appreciation for their customers or family. In one embodiment, the mats include a textile upper surface (such as a pile surface) and a solid backing. Because the mats are printed with reactive dyes, they are more capable of withstanding vigorous laundering without causing dye transfer onto other mats.

### BRIEF DESCRIPTION OF THE DRAWINGS

FIG. 1 is a plan view of the present information mat;

FIG. 2 is a cross-sectional view of the mat of FIG. 1, as taken along line A-A; and

FIG. 3 is a cross-sectional view of an alternate embodiment of the mat of FIG. 1, which further includes a secondary backing layer.

### DETAILED DESCRIPTION

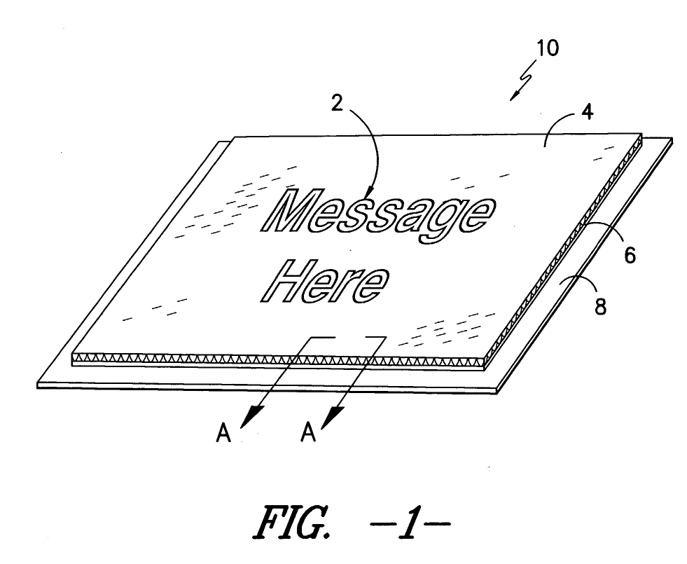

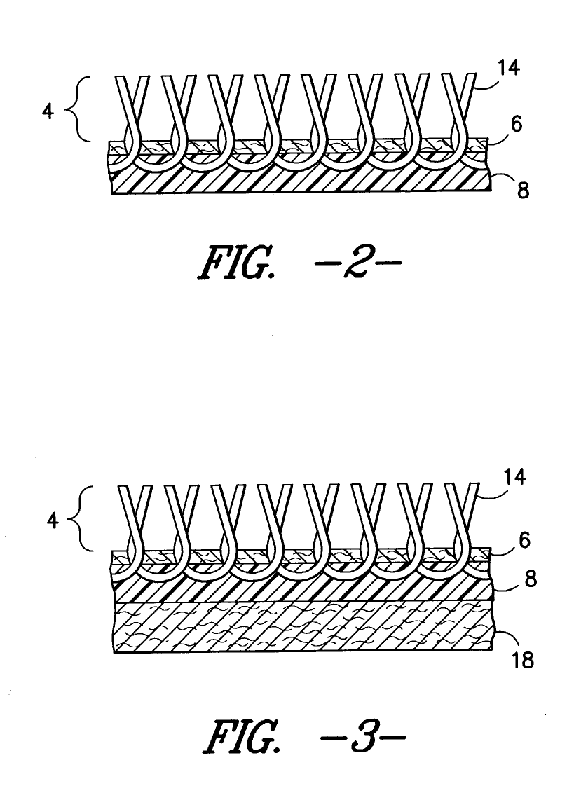

The present mat system includes a plurality of information mats, an example of which is shown in FIG. 1.

Such mats 10 have a textile upper surface 4, which may comprise a tufted cut-pile surface, a tufted loop-pile surface, a needle-punched surface, a bonded pile surface, a woven fabric, a knit fabric, a nonwoven fabric, or a combination thereof. Preferably, textile upper surface 4 is a tufted cut-pile surface, because of its appearance and dust control attributes. The yarns 14 comprising textile upper surface 4 are made from natural and/or synthetic fibers, including, but not limited to, nylon, polyester, acrylic, polypropylene, cotton, wool, or combinations thereof. Nylon is the preferred fiber type because of its durability, pile resistance, and colorfastness when dyed. Yarns 14 comprising upper surface 4 are preferably attached to and through a primary substrate 6, as will be described below, although yarns 14 could be punched directly into the backing 8.

Primary substrate 6, in which pile yarns 14 are preferably placed, is comprised of any woven or nonwoven material, such as, but not limited to, nylon, polypropylene, polyester, cotton, wool, acrylic, glass, or combinations thereof. The preferred primary substrate is a polyester nonwoven that is coated with nylon and, more preferably, that is dyed a dark color to mask the appearance of the substrate and to emphasize the color of the yarns. Speaking of the preferred substrate, the nylon component of substrate 6 tends to accept the dye used for yarns 14, further masking substrate 6 from mat users. One important aspect of using a nylon-coated polyester nonwoven substrate is its dimensional stability, particularly during dye processing, during the backing formation process, and during laundering. Alternately, a woven polypropylene substrate with either a nonwoven nylon cap or a nonwoven polypropylene cap may also be used.

Backing component 8 may be made of any durable material, including, but not limited to, rubber, polyvinyl chloride (PVC), thermoplastic elastomer (TPE), latex, or combinations thereof. Preferably, primary backing material 8 is comprised of nitrile rubber, because of its wash durability, tear strength, and overall performance.

Optionally, the present mat 10 may also include a secondary backing material 18, such as a woven or nonwoven fabric attached to the bottom of the backing material. This configuration is illustrated in FIG. 3. Secondary backing material 18 is preferably a felt-like material.

The message portion of the present mat (illustrated as 2 in FIG. 1) may be created by any patterning technique known in the art, including, but not limited to, dye injection, graphic tufting, screen printing, pad dyeing, flocking, or combinations thereof. Dye injection is preferred because of the unlimited pattern making capability and opportunity for mass customization. One piece of equipment capable of performing such patterning is described in U.S. Pat. No. 4,084,615 to Klein and Stewart.

Such patterning may be achieved by using acid dyes, basic or cationic dyes, disperse dyes, metallized or premetallized dyes, reactive dyes, or any combination thereof, although reactive dyes are most preferred. The use of reactive dyes in patterning is preferred, because they result in a product that has excellent washfastness over repeated laundering&

Washfastness has historically been a particular dilemma to the industrial laundries, which are often called upon to service dust control mats. In order to be cost-efficient, the laundry must wash all of their message mats together in large washing machines, rather than segregating mats by color. Because of the dyes used conventionally, the mat color transfers to other mats in the washing machine, causing cross-staining problems. For example, when laundering a red, a black, and a yellow mat together (each of which has been dyed with acid dyes), the black dye tends to migrate onto the red and the yellow mats. The red dye also tends to migrate onto the yellow mat. The result is that the mats that have lost dye appear faded, while the mats that receive dye appear dingy or dirty.

However, conventional wisdom in the laundry industry is that, if acid dyes (or dyes with similar transfer properties) are not used, then the mat colors will fade, over time, from exposure to sunlight. The industrial laundry, therefore, must choose between dye transfer problems and weather-related fading problems. Because light-fastness has historically been deemed more important to many industrial laundries, the prior mats have been made with conventional dyes that tend to have poor washfastness.

The present mat system addresses the problem of dye transfer by replacing acid dyes with reactive dyes. The wash durability of reactive dyes helps significantly reduce the likelihood of dye transfer during laundering, thus solving a significant problem experienced by the industrial laundries. Furthermore, since the intended use of the present mat system is typically in interior locations, the light-fastness of the reactive dyes is not problematic.

Turning now to specific embodiments of the present mat system, several examples will be presented. The present mat system is in no way to be limited to these examples, as variations are intended to fall within the scope and spirit of the claimed invention.

### EXAMPLE SET #1

### Factual Information Mats

Example 1A: Weather Mat

The mat system includes separate mats that are patterned in such a way as to convey weather conditions. These mats are patterned with text, characters, symbols, and/or graphics to suggest weather conditions such as “Sunny,” “Rainy,” “Cloudy,” “Snowy,” “Windy,” “Hot,” “Cold,” and the like. The mats are placed in a location visible to customers, so that they would learn the weather forecast for the present day. The weather information mats could be used individually or in combination to create more complex messages (such as “Sunny” and “Hot” or “Windy” and “Cold”). At any time during the day, should weather conditions change, the end-user could change the mat selection to a more appropriate message.

Such a mat may be useful in environments such as hotels where hotel guests may lack familiarity with local weather conditions. Hotel guests, viewing the mats in convenient or central locations, may then choose appropriate attire or outerwear. Especially when travelling internationally—for example, to a country with a language different from his own—the hotel guest is likely to appreciate a symbolic representation of the day's weather conditions.

Example 1B: Restroom, Public Bath, or Spa Mat

The mat system includes separate mats that are patterned in such a way as to convey the gender of the intended users of public restrooms, baths, spas, lockerrooms, and the like. In any location where users are segregated by gender, the present mat system may be used. Again, mats are patterned with text, characters, symbols, and/or graphics that indicate “Ladies” or “Gentlemen.” The end-user can place such mats at various locations to direct customers to the appropriate facility.

### EXAMPLE SET #2

### Directional Information Mats

Example 2A: Transportation Mat

The mat system includes separate mats that are used in transportation stations or terminals. Such mats are patterned with text, characters, symbols, and/or graphics that convey directional information to the end-user's customers. Examples of settings in which such a mat system would be useful include airports, bus stations, train stations, subway stations, and the like. Sample messages include “To Departures,” “To Arrivals,” “To Customs,” “To Check-out,” “To Track 24,” “To 2_{nd} Floor,” “To Gate A,” “To Emergency Exit,” and “Ground Transportation This Way.”

Example 2B: Postal Service Mat

The mat system includes separate mats that are used in postal delivery services. Such mats are patterned with text, characters, symbols, and/or graphics that convey messages to direct the customer to the appropriate area of the post office. Sample messages include “Customer Service,” “Domestic Delivery,” “International Delivery,” “Parcel Pick-up,” and the like. Customers would be directed by the mats to the area of the post office in which they are seeking service. The mat system, as described, could be used in government-operated postal services, as well as international package and document delivery services.

Example 2C: Bank Mat

The mat system includes separate mats that are patterned with text, characters, symbols, and the like to convey messages such as “Make Deposit Here,” “Money Transfer,” “Customer Service,” and “Loan Department.” The mats would direct bank customers to the appropriate locations within the bank, thus helping the customers more easily recognize the area of service that they are trying to locate.

### EXAMPLE SET #3

### Greeting Information Mats

Example 3A: Day-of-the-week Mat

The mat system includes separate mats that are patterned with text, characters, symbols, and the like that represent the days of the week. The end-user places the appropriate mat anywhere in an installation and changes the mat daily.

Example 3B: Public Greeting Mat

The mat system includes separate mats that are patterned with text, characters, symbols, and the like that convey a greeting to the end-user's customers. For example, in a hotel, one mat may be printed with the message “Good morning” and another printed with the message “Good night”. Such mats could be-placed in front of the elevator in such a way that the hotel patron would read the message on the way into or out of the elevator. The hotel patron would perceive that the hotel management is providing an extra service to him by the greeting.

Example 3C: Private Greeting Mat

The mat system includes separate mats that are patterned with text, characters, symbols, and the like that convey a greeting to the end-user's family and/or friends. For example, in the home, a mat may be printed with the message “Happy Anniversary” to celebrate the anniversary of the mat user, members of his family, or his friends. Other variations include the “Happy Birthday” mat, the “Congratulations” mat, the “Best Wishes” mat, and the like. Holiday themes, celebrating religious and secular occasions, are also contemplated. Furthermore, humorous themes may also be expressed. Mats featuring cartoon or other popular fictional characters are contemplated for children.

It should be noted that, because many of the private greeting mats will experience infrequent and sporadic use (e.g., an “Anniversary Mat” may only be used once annually), these mats may be placed in exterior locations without fear of significantly damaging the mat. Specifically, an “Anniversary Mat” may be placed outside a home on the desired day and then removed after some, likely short, time has passed. Because the mat's exposure to sunlight has been limited, the mat's appearance is unlikely to experience any detrimental effects.

Example 3D: Message-of-the-day Mat

The mat system includes separate mats that are patterned with text, characters, symbols, and the like that represent uplifting, inspirational, or other messages. These message mats could be used in combination with day-of-the-week mats, for instance. These mats are appropriate for public or private use.

### EXAMPLE SET #4

### Service Information Mats

Example 4A: Taxi Mat

The mat system includes separate mats that are patterned with text, characters, symbols, and the like that are used in taxis, limousines, and other hired cars. The mats provide a message to the service provider's customers. One particular example is “Thank you for using (name of car service)”, which is customized with the name of the particular car service provider.

Example 4B: Gaming Establishment Mat

The mat system includes separate mats that are patterned with text, characters, symbols, and the like that are used in casinos, pachinko parlors, or other gaming establishments. Separate mats convey messages such as “Ladies' Day”, “Good Luck”, and the like.

### EXAMPLE SET #5

### Example 5A: Time-Pertinent Mats

The mat system, or the display system, includes separate mats that are patterned with text, characters, symbols, and the like that are pertinent to the time during which it is displayed, such as a “Good Morning” or “Good Evening” mat. Day-of-the-week mats also fall into this category, as do some greeting mats and mats having a holiday or seasonal theme.

Example 5B: Location-Pertinent Mats

The mat system, or the display system, includes separate mats that are patterned with text, characters, symbols, and the like that are pertinent to the immediate physical area in which it is display, such as a “Make Deposits Here” mat.

Example 5C: Condition-Pertinent Mats

The mat system, or the display system, includes separate mats that are patterned with text, characters, symbols, and the like that are pertinent to the local conditions for which it is displayed, such as a “Hot and Sunny” weather mat.

Example 5D: Personal Message Mats

The mat system, or the display system, includes separate mats that are patterned with text, characters, symbols, and the like that are pertinent to personal messages, such as a “Happy Birthday” or “Happy Anniversary” mat.

We claim:

1. A system for conveying information in interior locations, said system comprising a plurality of floor mats,
each of said mats comprising a textile upper surface and a backing material attached to said textile upper surface, said textile upper surface being dyed at least a first color with reactive dyes,
wherein the information is selected from the group consisting of factual information, directional information, greeting information, and service information, and
wherein said information is printed, using reactive dyes, in at least a second color on said textile upper surface of each of said mats.

2. The system of claim 1 wherein said floor mats further comprise a primary substrate into which said plurality of yarns are placed.

3. The system of claim 2 wherein said primary substrate is a nonwoven fabric that is comprised of polyester and coated with nylon.

4. The system of claim 3 wherein said primary substrate is dyed a solid color, the solid color contrasting with at least a first color of said textile upper surface.

5. The system of claim 2 wherein said floor mats further comprise a secondary backing material.

6. The system of claim 5 wherein said secondary backing is a felt-like material.

7. The system of claim 1 wherein said backing material is selected from the group consisting of rubber, polyvinyl chloride (PVC), thermoplastic elastomer (TPE), latex, or a combination thereof.

8. The system of claim 7 wherein said backing material is nitrile rubber.

9. A process for conveying information in interior spaces, said process comprising the steps of:
(a) providing a mat system comprising a plurality of floor mats, each of said floor mats having a textile upper surface that has been dyed with reactive dyes and a backing material attached to said textile upper surface, each of said floor mats being printed with reactive dyes on said textile upper surface with a piece of information;
(b) selecting, for use, at least one of said floor mats, having information desired for its intended purpose; and
(c) placing said selected mat in a location appropriate for displaying said information.

10. The process of claim 9 wherein said mat system is used in a public building.

11. The process of claim 9 wherein said mat system is used in public transportation.

12. The process of claim 9 wherein said mat system is used in a private setting.

13. The process of claim 9 wherein said information is selected from the group consisting of factual information, directional information, greeting information, and service information.

14. A display system for use in association with a building, said system comprising a plurality of floor mats,
each of said floor mats having a textile upper surface that has been dyed with reactive dyes and a backing material attached to said textile upper surface,
wherein said system is used to convey messages,
wherein said messages are selected from the group consisting of factual information, directional information, greeting information, service information, messages pertinent to the time during which said system is displayed, messages pertinent to the immediate area in which said system is displayed, messages pertinent to the local conditions for which said system is displayed, and personal messages,
and wherein said messages are printed using reactive dyes.
